(19) United States
(12) Patent Application Publication
(10) Pub. No.: US 2015/0013174 A1
(43) Pub. Date: Jan. 15, 2015

(54) Chic Stick

(71) Applicant: Lynn Hanamura, Folsom, CA (US)

(72) Inventor: Lynn Hanamura, Folsom, CA (US)

(21) Appl. No.: 14/323,022

(22) Filed: Jul. 3, 2014

Related U.S. Application Data
(60) Provisional application No. 61/845,641, filed on Jul. 12, 2013.

(51) Int. Cl. B26B 21/52

(52) U.S. Cl. CPC B26B 21/52; B26B 21/521
USPC 30/526

(57) ABSTRACT

A shaving device is disclosed that provides a safe and convenient way for women to shave their legs, and minimizes having to bend over to reach legs and toes. The shaving device comprises a handle component, a razor, and a securing component that secures the razor to the handle component. Further, the handle component comprises two spaced apart connectors for attaching the securing component to the handle component and an elongated groove for stabilizing the razor. The razor is positioned in the elongated groove and then secured with the securing component to the handle component for use. An end of the handle component can also comprise a cord that acts as a handle to hang the shaving device when not in use.

### CROSS-REFERENCE

This application claims priority from Provisional Patent Application Ser. No. 61/845,641 filed Jul. 12, 2013.

### BACKGROUND

It is difficult for many women, including those who are pregnant, overweight, or recovering from surgery, to bend over and shave their legs and toes. Some women may try to prop their leg up against the wall or bathtub ledge, but they may lose their balance and fall. An effective solution is necessary.

The present invention provides a safe and convenient way for women to shave their legs, and minimizes having to bend over to reach legs and toes. The invention also reduces stress placed on the back, hips, and knees while shaving. This shaving device benefits women who are pregnant, overweight, or recovering from surgery, or any woman in general.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a shaving device that provides a safe and convenient way for women to shave their legs, and minimizes having to bend over to reach legs and toes. The shaving device comprises a cylindrical handle component, a razor, and a securing component that secures the razor to the cylindrical handle component. Further, the handle component comprises two spaced apart connectors for attaching the securing component to the handle component and an elongated groove for stabilizing the razor. The razor is positioned in the elongated groove and then secured with the securing component to the handle component.

In a preferred embodiment, the handle component can be shaped such that both ends are tapered. One of the tapered ends comprises the elongated groove for stabilizing the razor, wherein the securing component is a pliable band that is looped around the razor and attached to the two connectors, securing the razor within the elongated groove of the handle component. The second tapered end comprises a cord that acts as a handle to hang the shaving device when not in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the shaving device in accordance with the disclosed architecture.

FIG. 2 illustrates a perspective view of the shaving device disassembled in accordance with the disclosed architecture.

FIG. 3 illustrates a perspective view of the shaving device being secured together in accordance with the disclosed architecture.

FIG. 4 illustrates a perspective view of the shaving device assembled together in accordance with the disclosed architecture.

FIG. 5 illustrates a perspective view of the shaving device in use in accordance with the disclosed architecture.

FIG. 6 illustrates a top perspective view of various disposable razors that can be used with the shaving device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides a safe and convenient way for women to shave their legs, and minimizes having to bend over to reach legs and toes. The device also reduces stress placed on the back, hips, and knees while shaving. The shaving device benefits women who are pregnant, overweight, or recovering from surgery, or any woman in general.

The shaving device comprises a handle component, a razor, and a securing component that secures the razor to the handle component. Further, the handle component comprises two spaced apart connectors for attaching the securing component to the handle component and an elongated groove for stabilizing a variety of disposable razors. Including, but not limited to, oval handle, round handle, and/or square handle disposable razors. The razor is positioned in the elongated groove and then secured with the securing component to the handle component for use. An end of the handle component can also comprise a cord that acts as a handle to hang the shaving device when not in use.

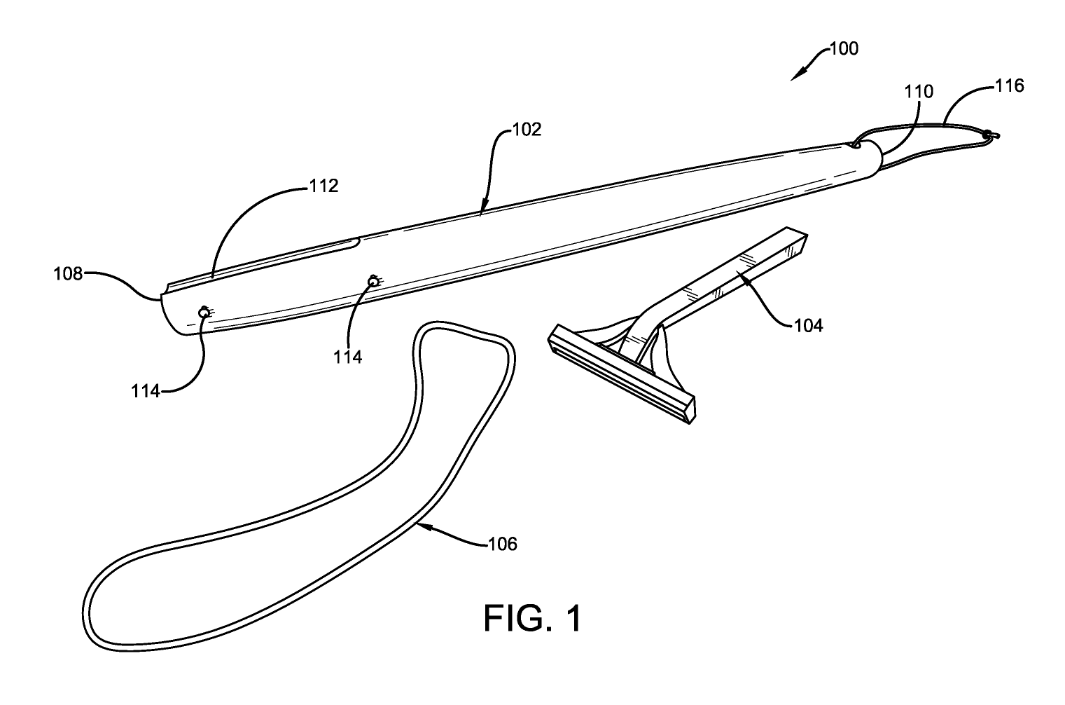

Referring initially to the drawings, FIGS. 1-4 and 6 illustrate the shaving device 100 that provides a safe and convenient way for women to shave their legs, and minimizes having to bend over to reach legs and toes. The shaving device 100 comprises a cylindrical handle component 102, a variety of disposable razors 104, and a securing component 106 that secures the razor 104 to the cylindrical handle component 102 (as shown in FIG. 1).

The cylindrical handle component 102 comprises a first end 108 and a second end 110. Typically, the handle component 102 is cylindrical in shape, but can be any suitable shape as is known in the art, such as a rectangular prism, etc. The handle component 102 would generally be constructed of wood, though any other suitable material may be used to manufacture the handle component 102 as is known in the art without affecting the overall concept of the invention, such as polymers, etc.

The handle component 102 can also comprise a variety of colors and designs to suit user and manufacturing preference. While the shape and size of the handle component 102 may vary greatly depending on the wants and needs of a user, the handle component 102 is approximately between 14 and 16 inches in length as measured from a first end 108 to a second end 110, and approximately 1 inch in diameter, at its thickest point.

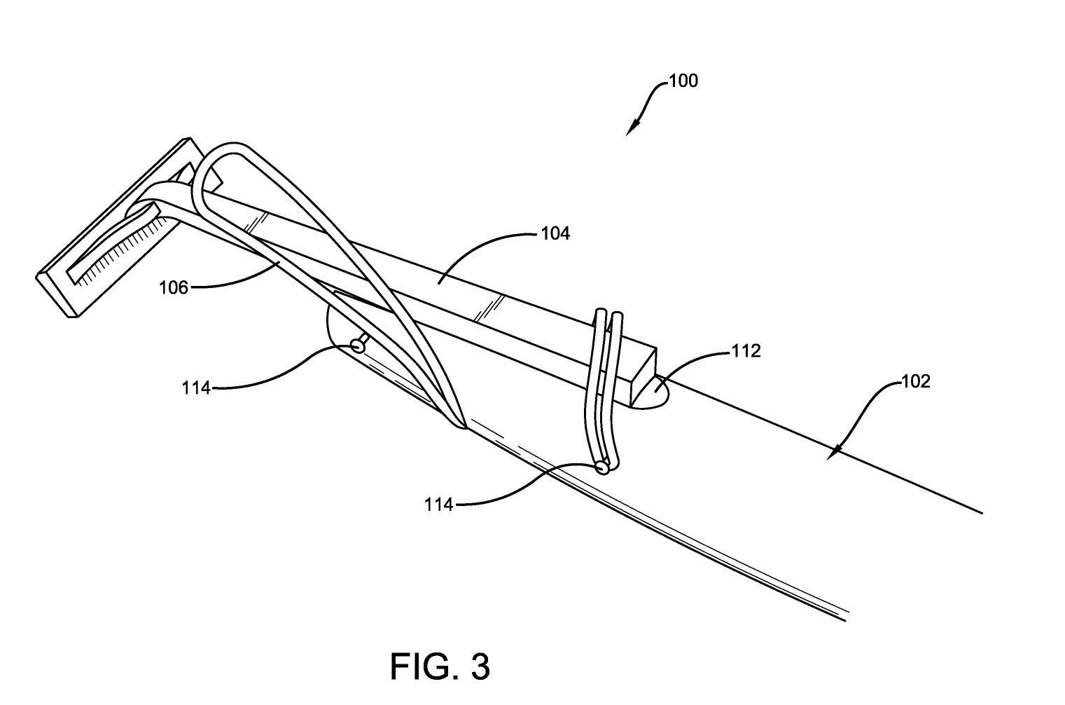

Furthermore, the handle component 102 can be shaped such that both the first end 108 and the second end 110 are tapered. Thus, the handle component 102 can be approximately 1 inch in diameter, at its thickest point and then can taper at both the first 108 and the second 110 ends to approximately 0.75 inches in diameter. Additionally, the handle component 102 comprises an elongated groove 112 positioned on the first end 108. The elongated groove 112 stabilizes the razor 104 on the handle component 102. The elongated groove 112 can be any suitable shape and size and can accommodate a variety of different disposable razors 104 (as shown in FIG. 3).

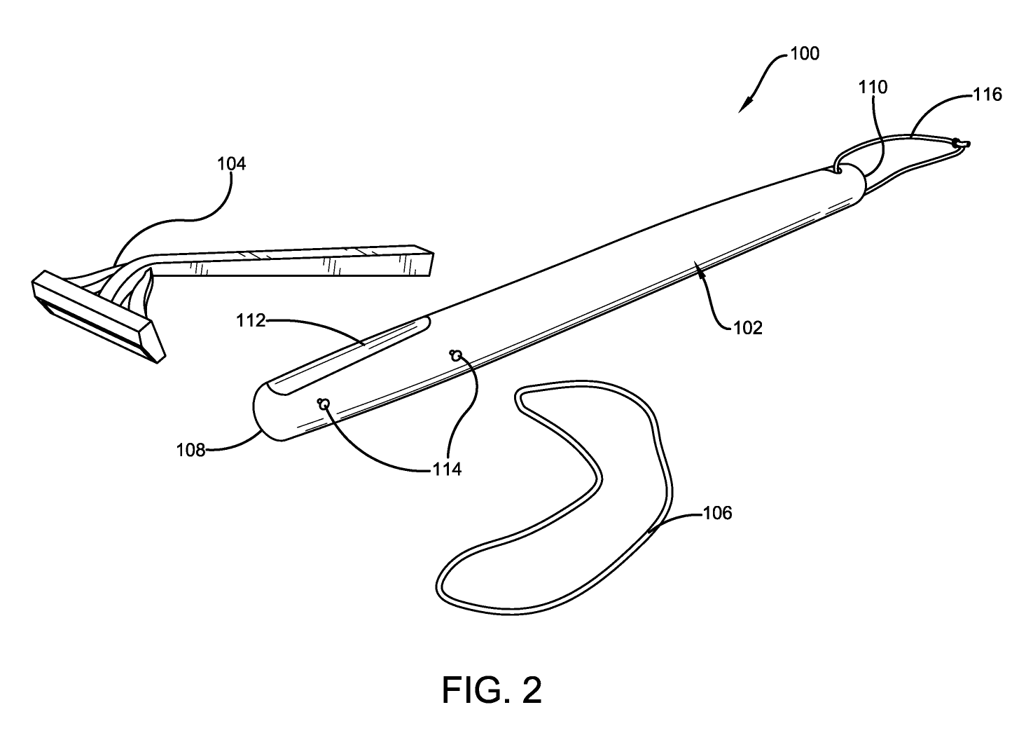

Further, the first end 108 of the handle component 102 comprises two spaced apart connectors 114 for attaching the securing component 106 to the handle component 102. The connectors 114 can be any suitable connector as is known in the art, such as a nail, screw, etc. The connectors 114 can also be manufactured out of any suitable material such as brass, etc. Typically, two connectors 114 are needed to attach the securing component 106 to the handle component 102, though any suitable number of connectors 114 can be used as is known in the art, and depending on the needs and wants of a user. The connectors 114 are typically placed on the same side of the first end 108, in a spaced apart relationship, but can positioned in any suitable place on the handle component 102 as is known in the art, and depending on the needs and wants of a user (as shown in FIG. 2).

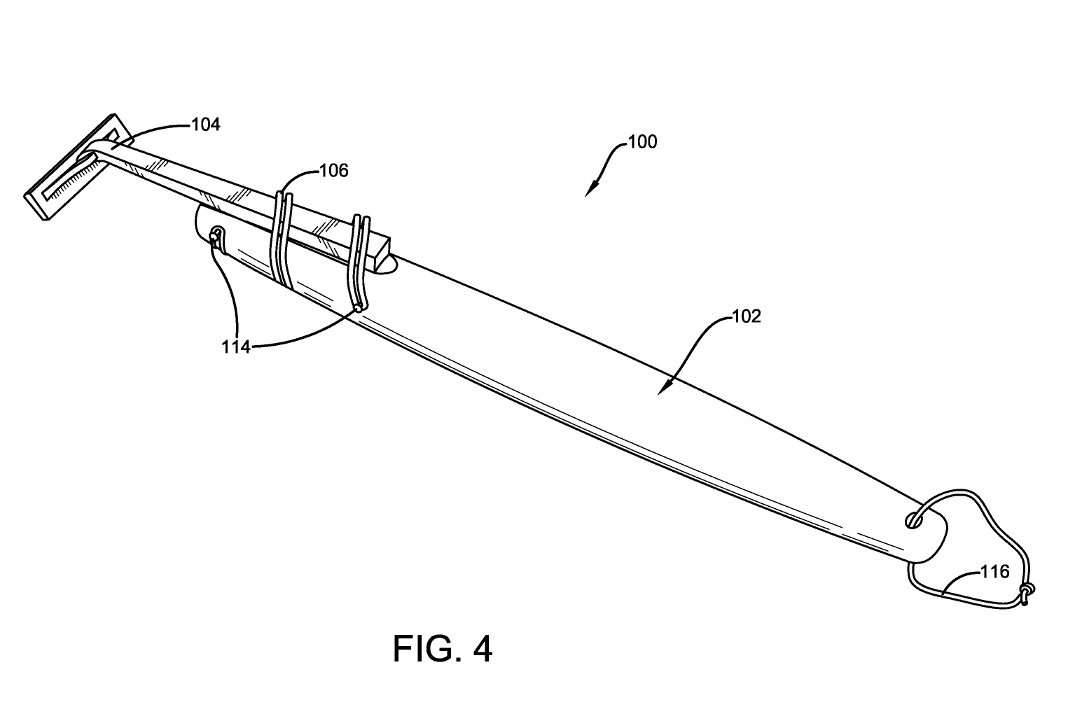

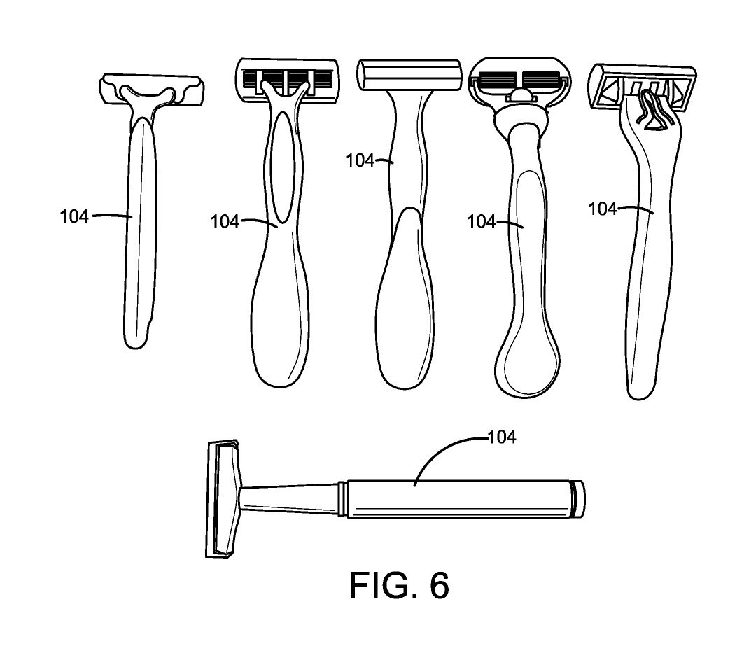

Typically, any type of disposable razor can be used with the handle component 102, or any other suitable type of razor as is known in the art, as long as the razor can be safely used around water (as shown in FIG. 6). The razor 104 is positioned in the elongated groove 112 and then secured with the securing component 106 to the handle component 102. Typically, the securing component 106 is a pliable band that is looped around the razor 104 and attached to the two connectors 114, securing the razor 104 to the handle component 102 (as shown in FIG. 4). However, any suitable securing component 106 as is known in the art can be utilized to secure the razor 104 to the handle component 102.

Furthermore, the second end 110 of the handle component can comprise a cord 116 that acts as a handle to hang the shaving device 100. The cord 116 is typically a nylon cord but can be any suitable cord or other handle component as is known in the art to allow the shaving device 100 to be hung when not in use.

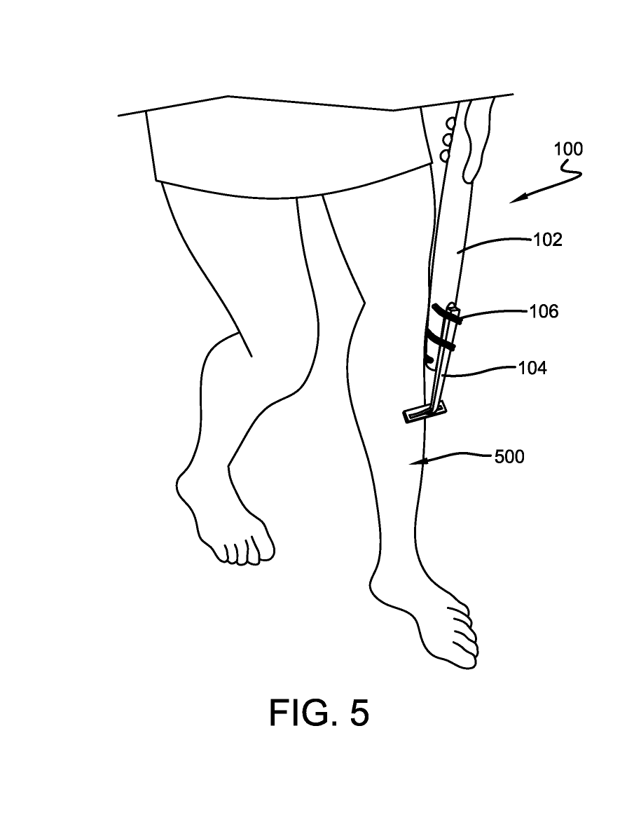

FIG. 5 illustrates the shaving device 100 in use. As stated supra, the shaving device 100 comprises a handle component 102, a razor 104, and a securing component 106 that secures the razor 104 to the handle component 102. Further, the handle component 102 comprises two spaced apart connectors 114 for attaching the securing component 106 to the handle component 102 and an elongated groove 112 for stabilizing the razor 104. The razor 104 is positioned in the elongated groove 112 and they are secured with the securing component 106 to the handle component 102 for use. An end of the handle component 102 can also comprise a cord 116 that acts as a handle to hang the shaving device 100 when not in use.

In operation, a user 500 would choose the size and/or specific color of the handle component 102 and meets their needs and/or wants, depending on the type, size, and/or shape of the razor 104 they intend to use with it. The user 500 would then choose the size and/or type of razor 104 that meets their needs and/or wants. The user 500 would then place the razor 104 in the elongated groove 112 of the handle component 102, with the blade part of the razor 104 protruding out from the elongated groove 112, at a length based on the user's needs and/or wants. The user 500 would then secure the razor to the handle component via the securing component 106.

Specifically, the user 500 would secure an end of the pliable band (securing component 106) around one of the connectors 114. The user 500 would place the razor 104 in the elongated groove 112 of the handle component 102 with the blade end protruding out from the elongated groove 112. Then, the user 500 would wrap the pliable band around the razor 104 and would secure the second end of the pliable band to the second connector 114, thus securing the razor 104 within the elongated groove 112 of the handle component 102. Once secure, the razor 104 can be used normally, but without the extra step of having to bend over and touch your legs.

After the user 500 is done shaving with the shaving device 100, the user 500 can hang the shaving device 100 up in the shower or bath, by utilizing the cord 116 that is secured to the end of the handle component 102. Thus, the shaving device 100 reduces stress placed on the back, hips, and knees while shaving, as the device minimizes bending over to shave.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shaving device, comprising:
a cylindrical handle component comprising a first end and a second end;
a razor; and
a securing component that secures the razor to the first end.

2. The shaving device of claim 1, wherein the first end comprises an elongated groove for stabilizing the razor on the cylindrical handle component.

3. The shaving device of claim 2, wherein the first end comprises two spaced apart connectors for attaching the securing component.

4. The shaving device of claim 3, wherein the securing component is a pliable band that is looped around the razor and attached to the two connectors, securing the razor to the cylindrical handle component.

5. The shaving device of claim 1, wherein both the first and the second ends of the cylindrical handle component are tapered.

6. The shaving device of claim 5, wherein the second end comprises a cord that acts as a handle to hang the shaving device.

7. The shaving device of claim 1, wherein the razor is a disposable razor that can be used and replaced.

8. The shaving device of claim 1, wherein the cylindrical handle component is manufactured of wood.

9. The shaving device of claim 1, wherein the two connectors are manufactured of brass.

10. A shaving device, comprising:
a cylindrical handle component comprising a first end and a second end;
a disposable razor; and
a securing component that secures the razor to the first end; and
wherein the first end comprises an elongated groove for stabilizing the razor on the cylindrical handle component.

11. The shaving device of claim 10, wherein both the first and the second ends of the cylindrical handle component are tapered.

12. The shaving device of claim 11, wherein the second end comprises a cord that acts as a handle to hang the shaving device.

13. The shaving device of claim 10, wherein the first end comprises two spaced apart connectors for attaching the securing component.

14. The shaving device of claim 13, wherein the securing component is a pliable band that is looped around the razor and attached to the two connectors, securing the razor to the cylindrical handle component.

15. The shaving device of claim 10, wherein the cylindrical handle component is approximately 14 to 16 inches in length.

16. The shaving device of claim 15, wherein the cylindrical handle component is approximately 1 inch in diameter, at thickest point and tapers at both the first and the second ends to approximately 0.75 inches in diameter.

17. A shaving device, comprising:
a cylindrical handle component comprising a first end and a second end;
a disposable razor; and
a pliable band that secures the razor to the first end; and
wherein the first end comprises an elongated groove for stabilizing the razor on the cylindrical handle component; and
wherein the first end comprises two spaced apart connectors and the pliable band is looped around the razor and attached to the two connectors, securing the razor to the cylindrical handle component.

18. The shaving device of claim 17, wherein the second end comprises a cord that acts as a handle to hang the shaving device.

19. The shaving device of claim 17, wherein both the first and the second ends of the cylindrical handle component are tapered.

20. The shaving device of claim 19, wherein the cylindrical handle component is approximately 1 inch in diameter, at thickest point, and tapers at both the first and the second ends to approximately 0.75 inches in diameter.
